(19) United States
(12) Patent Application Publication
(10) Pub. No.: US 2006/0106807 A1
(43) Pub. Date: May 18, 2006

(54) System and method for transferring a file in advance of its use

(75) Inventors: John DeVitis, Kirkland, WA (US); George Johnston, Bellevue, WA (US)

Correspondence Address: SHOOK, HARDY & BACON L.L.P.;(c/o MICROSOFT CORPORTATION), 2555 GRAND BOULEVARD, KANSAS CITY, MO, 64108-2613, US

(73) Assignee: Microsoft Corporation, Redmond, WA (US)

(21) Appl. No.: 10/991,587

(22) Filed: Nov. 18, 2004

(51) Int. Cl. G06F 17/30; G06F 7/00

(52) U.S. Cl. 707/10

(57) ABSTRACT

The invention relates to a system, methods, and computer-readable media for transferring one or more files to a computer in advance of their use by the computer. In accordance with one method of the invention, the computer sends a request for instructions to acquire at least one predetermined file. The request includes information regarding the location of a cache on the computer. The computer receives the instructions to acquire the file, as well as at least one cookie, which includes information regarding the file and the location of the cache. Based on the instructions, the computer obtains the file and stores it in the cache in advance of its use by the computer. If a web page that includes the file is requested, the request for the web page includes the cookie. The computer then receives data that represents that web page and includes a reference to the file stored in the cache at the computer. The reference may be used to open the file stored in the cache.

### CROSS-REFERENCE TO RELATED APPLICATIONS

Not applicable.

### STATEMENT REGARDING FEDERALLY SPONSORED RESEARCH OR DEVELOPMENT

Not applicable.

### TECHNICAL FIELD

The present invention relates to computing environments. More particularly, the present invention relates to a system and method for transferring one or more files from a server to a local computer before their use by the local computer.

### BACKGROUND OF THE INVENTION

Businesses and consumers are increasingly looking to the Web to deliver content. More and more, this consists of large content files and may include rich media assets such as high-bit rate videos and photos. Delivering these large content files and high quality multimedia assets requires large amounts of costly bandwidth. As a result, the process of downloading large content files associated with Web applications adversely affects server performance and increases delivery costs. Thus, as Web applications increasingly utilize large content files in their designs, overall site performance is adversely affected by download latency. In addition, large numbers of simultaneous downloads create a spike in egress that in turn drives up delivery costs. Furthermore, network-induced streaming delays and errors may be caused when multiple users attempt to simultaneously download large content files from a server. As a result, the end user experience may often be degraded.

One way to address the problems associated with delivering large content files to multiple end users is to transfer files as a background process when network, server, and/or client usage is low. The concept of background file transfer has been applied to software updates and other file types. In web applications, however, these solutions require a download program and a control written for the browser. These approaches fail to provide a single solution that is compatible among various browsers.

Accordingly, the ability to transfer large content files as a background process in advance of their actual use would be desirable to provide servers a solution to effectively distribute egress loads and control costs. Additionally, it would be advantageous to eliminate the need for a browser control, which would simplify client development and enhance browser compatibility. Furthermore, it would be desirable to benefit end user experience by eliminating network-induced streaming delays and errors, while providing the capability to access large content files at speeds that exceed the capacity of broadband streaming services.

### BRIEF SUMMARY OF THE INVENTION

The present invention is directed to a system, methods, and computer-readable media for transferring one or more files to a computer in advance of their use by that computer. In accordance with an embodiment of the invention, files to be transferred and cached are identified, and a list of these files is maintained on a server. A client application running on a computer communicates with the server to determine what files should be obtained. In addition, the client application provides the server information regarding the location of a cache on the computer that stores obtained files, as well as a list of files that have already been obtained. Using the provided information, the server generates a cookie containing information regarding cached files and a cookie containing information regarding the location of the cache on the computer. The server then transfers the cookies to the computer.

After determining what files to obtain, the client application initiates a background file transfer process and caches the files for future use. Thus, when a user of the computer visits a web page containing a file that has already been cached, the web browser sends the cookies with a request for the web page. The cookies instruct the server to include a reference to the file stored in the computer's cache as opposed to the file stored on the server. When the web page is rendered on the computer and the user selects the image tag associated with the file, the file stored in the local cache is used as opposed to the file being downloaded from the server.

Thus, in one aspect, an embodiment of the present invention relates to a method for transferring at least one predetermined file from a server computer to a client computer in advance of its use by the client computer. The method includes the step of sending from the client computer a request for instructions to acquire at least one predetermined file. The client computer includes a cache, and the request includes information regarding the location of the cache. Next, the client computer receives the instructions to acquire the at least one predetermined file. In addition, the client computer receives at least one cookie. The at least one cookie includes information regarding the at least one predetermined file and the information regarding the location of the cache. Based on the instructions, the client computer obtains the at least one predetermined file. The client computer then stores the at least one predetermined file in the cache in advance of its use by the client computer.

In another aspect of the invention, an exemplary embodiment is directed to a method for transferring at least one file from a server computer to a client computer in advance of the client computer's use of the file. The method includes identifying at least one file to be transferred in advance of any specific use request by the client computer. Next, the method includes the step of sending to the client computer from the server computer instructions to request the identified at least one file. The method also includes transferring to the client computer from the server computer at least one cookie associated with the identified at least one file. The cookie includes information regarding the at least one file and the proper storage location of the at least one file on the client computer.

In yet another aspect, an exemplary embodiment of the invention takes the form of a system for transferring at least one predetermined file from a server computer to a client computer in advance of its use by the client computer. The system includes a communicating component, a receiving component, a file obtaining component, and a file storage component. The communicating component sends from the client computer a request for instructions to acquire at least one predetermined file. The client computer includes a cache, and the request includes information regarding the location of the cache. The receiving component receives at the client computer the instructions to acquire the at least one predetermined file and receives at least one cookie. The at least one cookie includes information regarding the at least one predetermined file and the information regarding the location of the cache. The file obtaining component is able to obtain the at least one predetermined file based on the instructions. The storage component stores the at least one predetermined file in the cache in advance of its use by the client computer.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a simplified block diagram of an exemplary communications system in which exemplary embodiments of the present invention may be employed;

FIG. 3 is a flow diagram showing a method for obtaining cookies and determining which files to cache in accordance with an embodiment of the present invention;

FIG. 4 is a simplified block diagram showing elements of the client request and server response in accordance with an embodiment of the present invention;

FIG. 5 is a flow diagram showing a method for transferring files in accordance with an embodiment of the present invention;

FIG. 6 is a flow diagram showing a method for using cookies and a cached file in accordance with an embodiment of the present invention.

### DETAILED DESCRIPTION OF THE INVENTION

The present invention provides a system, methods, and computer-readable media for transferring files in advance of their use. In accordance with an embodiment of the invention, media files that are expected to experience high demand are identified, and a list of these files is maintained on a server. A client application running on a computer communicates with the server to access the list and determine what files should be downloaded. In addition, the client application provides the server information regarding the location of the cache for storing the media files on the computer, as well as a list of files currently cached. In response, the server generates a cookie with information regarding cached files and a cookie containing information regarding where media files are cached on the computer.

After the client application determines what media files to download, it initiates a background file transfer process, which transfers the files during periods of low server, network, and/or client's computer usage. Once media files are downloaded, they are cached for future use. Thus, when a user of the computer visits a web page containing a media file, the web browser sends the cookies with a request for the web page. The cookies instruct the server to include a reference to the media file stored in the computer's cache as opposed to the media file stored on the server. When the web page is rendered on the computer and the user selects the image tag associated with the media file, the media file stored in the local cache is used as opposed to the file being downloaded from the server.

Having briefly described an overview of the present invention, an exemplary operating environment for the present invention is described below.

Exemplary Operating Environment

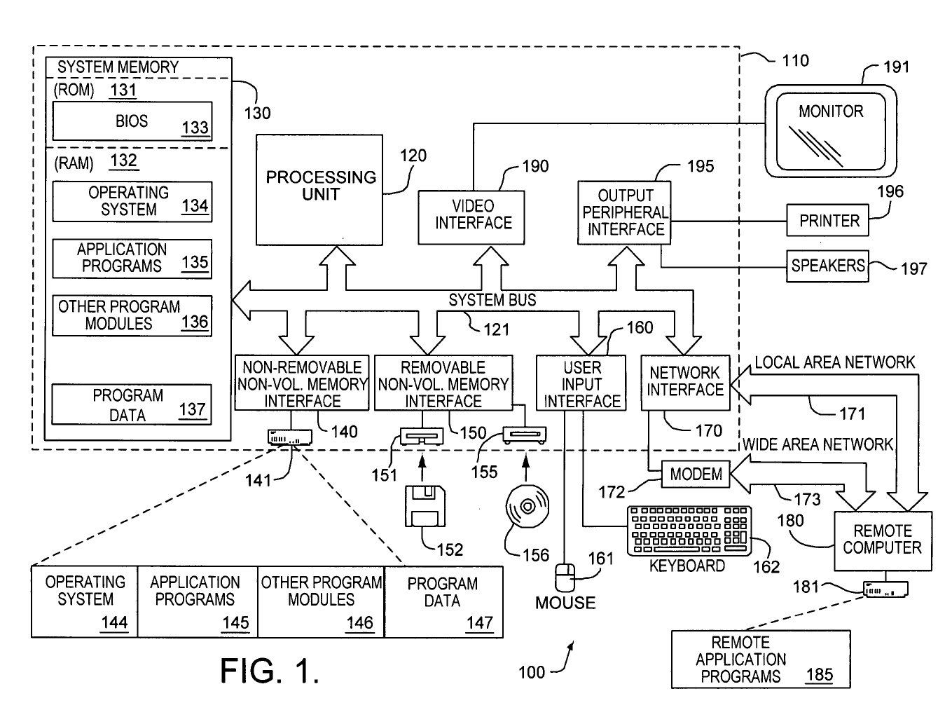

Referring to the drawings in general and initially to FIG. 1 in particular, wherein like reference numerals identify like components in the various figures, an exemplary operating environment for implementing the present invention is shown and designated generally as computing system environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the present invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer-readable media. Computer-readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The system memory 130 includes computer storage media in the form of volatile and/or nonvolatile memory such as read only memory (ROM) 131 and random access memory (RAM) 132. A basic input/output system (BIOS) 133, containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks (DVDs), digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer-readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other programs 146 and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the network interface 170, or other appropriate mechanism. In a networked environment, program modules depicted relative to the computer 110, or portions thereof, may be stored in a remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131, instructs the processing unit 120 to load the operating system, or necessary portion thereof, from the hard disk drive 141 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

Exemplary Communications System

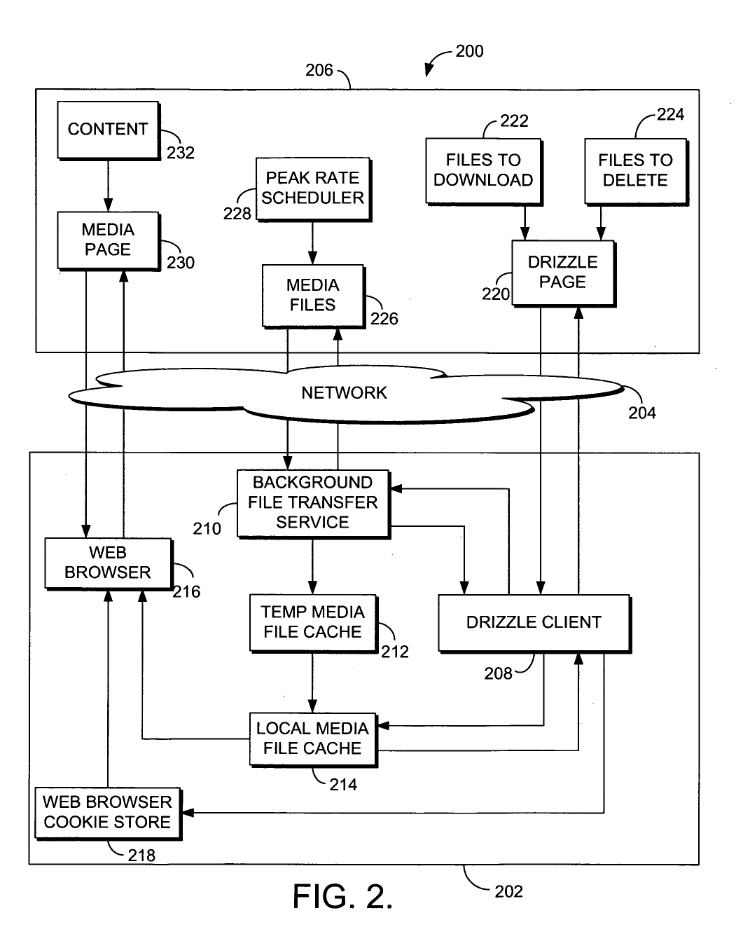

Referring to FIG. 2, a simplified block diagram is shown of an exemplary communications system in which exemplary embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

As shown in FIG. 2, communications system 200 includes local computer 202, network 204, and server 206. Local computer 202 may be any type of general purpose computing device, such as computer 110. In addition, server 206 may be any type of remote computing device, such as remote computer 180. Although local computer 202 and server 206 are each shown as a single device, each may be comprised of multiple, separate components. For example, server 206 may be comprised of multiple servers operating to perform the functions described herein.

Local computer 202 and server 206 are able to communicate via network 204. Network 204 may include one or more wide area networks (WANs), such as WAN 173, and/or one or more local area networks (LANs), such as LAN 171, as well as one or more public networks, such as the Internet, and/or one or more private networks.

In addition to the components described with respect to computer 110, local computer 202 includes drizzle client 208, which is a program running on local computer 202 and is responsible for coordinating methods of the present invention. It has access to the system memory of local computer 202, as well as to network 204. Drizzle client 208 communicates with a drizzle page 220 via network 204 to determine what media files should be cached on local computer 110. In addition, drizzle client 208 receives cookies from drizzle page 220 and is able to write the cookies to web browser cookie store 218 using a contained instance of web browser 216. In other words, a contained instance of web browser 216 is running on drizzle client 208. Drizzle client 208 also initiates the transfer of media files from server 206 by directing a background file transfer service (BFTS) 210 to obtain the files.

BFTS 210 may be any type of file transfer manager, such as BITS (Background Intelligent Transfer Service), that is capable of downloading files in the background to reduce interference with other activities. BFTS 210 monitors local computer 202 usage, as well as network 204 usage, to determine the current load each is experiencing. If either usage reaches a certain threshold, BFTS 210 may suspend a file transfer until the usage has decreased. Once usage decreases, BFTS 210 resumes any pending transfers. BFTS 210 may also have the ability to make persistent requests. Even after local computer 202 is shutdown or BFTS 210 is suspended, file transfers are resumed when local computer 202 is started up again or BFTS 210 is reinitiated. In addition, BFTS 210 periodically retries any file transfer that is refused by server 206.

Media files transferred from server 206 by BFTS 210 are temporarily stored in a temporary media file cache 212. The files are subsequently stored in a local media file cache 214. Because temporary media file cache 212 may be a subdirectory of local media file cache 214, moving media files from the former cache to the latter cache may be accomplished by a file rename.

Local computer 202 also has a web browser 216, such as Internet Explorer or Netscape, which provides access to Web content located on remote computers, such as server 206. Associated with web browser 216 is web browser cookie store 218. Cookies received by web browser 216 from servers, such as server 206, are written to web browser cookie store 218.

Among other components, server 206 includes drizzle page 220, media files 226, a peak rate scheduler 228, and a media page 230. Drizzle page 220 responds to requests from drizzle client 208 with information regarding what media files local computer 202 should cache. To accomplish this, drizzle page 220 maintains a list of files to download 222. The files indicated in list 222 may be selected by a number of methods. One way in which media files may be chosen to be included in list 222 is through an editorial process, in which an estimation is made of what media files will be heavily requested during a particular period. For example, a movie trailer for a popular upcoming movie may be expected to experience large numbers of requests around the time of the movie's release.

Another method by which media files may be chosen is by a personal preference process, whereby list 222 may be tailored to individual users. Under this approach, a user may indicate personal preferences with respect to what media files the user may request. For example, a user may indicate a preference for sports. As a result of the indication, list 222 may include video highlights of recent sporting events.

Drizzle page 220 may also maintain a list of files to delete 224. This list represents media files that are no longer experiencing a high number of requests. Since the likelihood that a user would request such media files is low, these files are included in list 224 to instruct local computer 202 to delete the files from local media file cache 214.

Media files 226 represent any type of file that may be stored on server 206 and requested by a user. By way of example and not limitation, the files may be rich media assets, such as high-bit rate videos and photos, which require large amounts of bandwidth for transmission. The files may also be content such as newspapers, magazines, advertisements, JavaScript files, CSS files, and data files. Server 206 may also maintain web pages, such as media page 230, which may be requested by a user. Media page 230 comprises content 232, which may include text, graphics, scripts, and files.

The delivery of media files 226 by server 206 may be controlled by peak rate scheduler 228. Scheduler 228 monitors server usage and on a regular interval alters the amount of bandwidth that server applications are permitted to use. As a result, transfer rates for media files 226 may be throttled to control the server's egress loads.

Exemplary Method for Transferring Media Files

The subject matter of the present invention is described with specificity herein to meet statutory requirements. However, the description itself is not intended to limit the scope of this patent. Rather, the inventor has contemplated that the claimed subject matter might also be embodied in other ways, to include steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed.

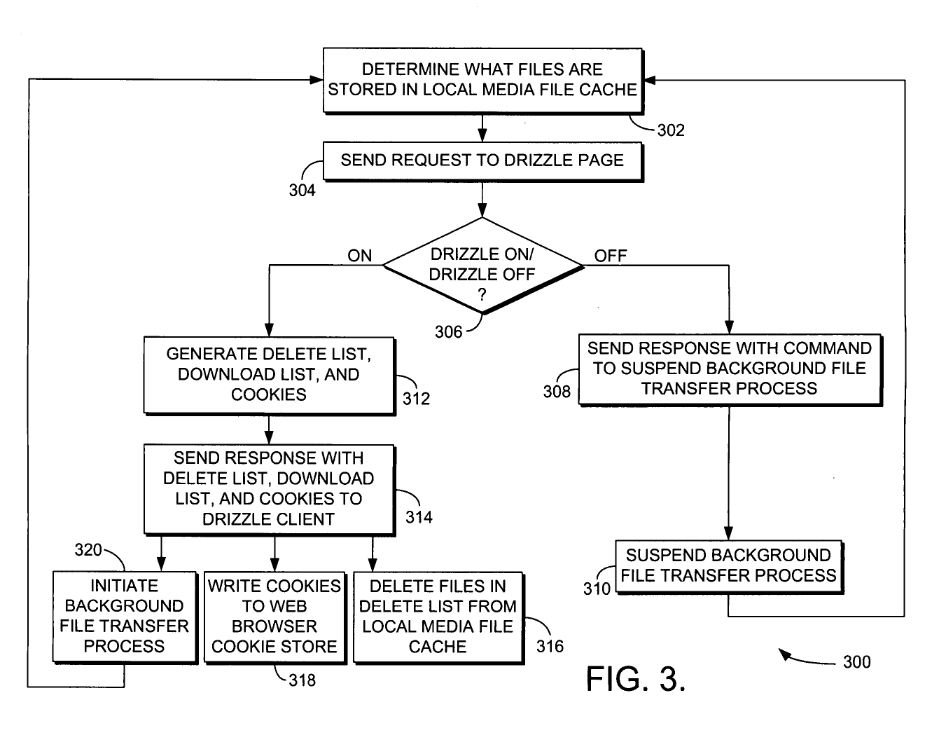

As previously mentioned, the present invention relates to a system and method for downloading and caching files prior to their use. Turning to FIG. 3, a flow diagram of an exemplary embodiment of the invention is illustrated which shows a method 300 through which local computer 202 determines which media files to cache and receives cookies from server 206. The process begins at step 302 when drizzle client 208 determines what media files are currently stored in local media file cache 214. These files may have been downloaded from server 206 by BFTS 210 and stored in local media file cache 214 in a previous iteration of the current invention. After determining the files that are currently cached, drizzle client 208 creates a directory of the files.

At step 304, drizzle client 208 sends a message to drizzle page 220, requesting information regarding which media files should be cached and requesting cookies for files it will cache. The message may consist of an HTTP post that includes two variables. The first variable is the directory path of local media file cache 214. The second variable is the list of files that have already been successfully downloaded and stored in the cache.

Drizzle page 220 preferably has a drizzle on/drizzle off flag, as shown at step 306, which is used to instruct drizzle client 208 to suspend the file transfer process during periods when server 206 is experiencing high levels of usage. Server 206 can set the flag to off when the load on the server reaches a predetermined threshold. This is one way in which requests for media files from server 206 can be managed to reduce traffic during times of peak usage. The flag is checked whenever drizzle client 208 contacts drizzle page 220. As shown at step 308, if the server is busy, the flag is designated as drizzle off and drizzle page 220 sends a response to drizzle client 208 to suspend any background file transfer that has already been initiated and is pending. In response, at step 310, drizzle client 208 commands BFTS 210 to suspend any pending file transfer. Any transfer that has begun will not be deleted, however. Instead, when drizzle client 208 sends another request to drizzle page 220 and receives a response indicating that the flag is designated as drizzle on, drizzle client 208 will instruct BFTS 210 to initiate the background file transfer process, which will resume any suspended transfers.

If server 206 is not experiencing high levels of usage such that the flag is designated as drizzle on, drizzle page 220 performs three tasks, as shown at step 312. First, drizzle page 220 generates a download list, which comprises a list of files that drizzle client 208 is instructed to download and cache. Drizzle page 220 generates the download list by comparing the list of files currently stored on local media file cache 214 with the list of files to download 222. Any file indicated on list 222 that is not currently stored on local media file cache 214 is added to the download list.

Second, drizzle page 220 generates a delete list, which is a list of files that drizzle page 208 is instructed to delete from local media file cache 214. Drizzle page 220 generates the delete list by comparing the list of files currently stored on local media file cache 214 with the list of files to delete 224. Any file that is common between the two lists is added to the delete list.

Third, drizzle page 220 generates cookies for local computer 202. One cookie enumerates each file that is resident in local media file cache 214 and available for use. Thus, the cookie contains a list of files that includes the files currently stored on local media file cache 214 minus the files indicated in the list of files to delete 224. Because files in the list of files to download 222 are net yet cached, the files are not included in the list. Also, because files in the list of files to delete 224 will be removed from the cache and no longer available for use, the files are likewise not included in the list. Drizzle page 220 also uses the directory information for local media file cache 214 that was supplied by drizzle client 208 to generate a cookie echoing to local computer 202 the base directory of the cached files. The cookies are named in such a way as to reduce the chance of other cookies in the domain interfering with these cookies.

As shown at step 314, drizzle page 220 sends to drizzle client 208 a response that includes the download list, the delete list, and the cookies. After receiving the response, drizzle client 208 performs three tasks. First, as shown at step 316, drizzle client 208 deletes the files designated in the delete list from local media file cache 214. Second, as shown at step 318, drizzle client 208 writes the cookies to web browser cookie store 218. Drizzle client 208 uses a contained instance of web browser 216 to gain access and write the cookies to web browser cookie store 218. Third, as shown at step 320, drizzle client 208 initiates the background file transfer process to download the files designated in the download list.

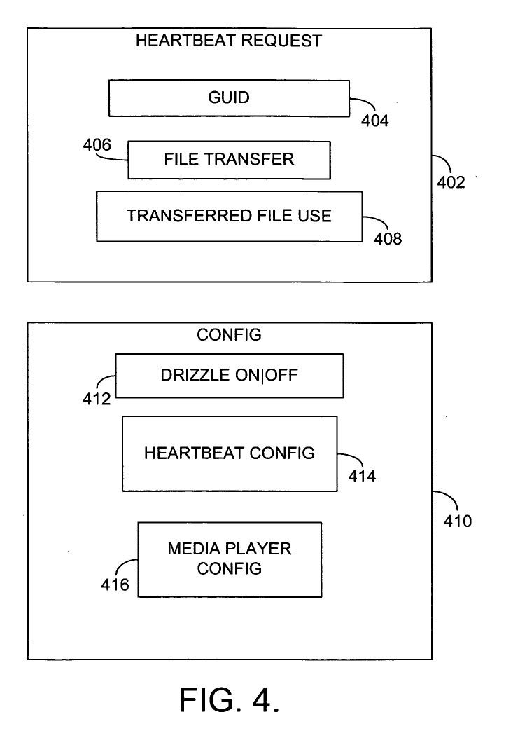

FIG. 4 shows a simplified block diagram illustrating elements of an exemplary embodiment of the request from drizzle client 208 and the response from drizzle page 220. The request from drizzle client 208 is a heartbeat request 402 and includes a unique but non-personally identifiable GUID (globally unique identifier) 404 to track the computer's file transfers 406, as well as subsequent uses 408 of the transferred files by the computer. This mechanism allows for the determination of whether transferring the files prior to their use is effective.

The response from drizzle page 220 is a config response 410 and includes a drizzle on/off indication 412 that informs drizzle client 208 whether the drizzle flag has been designated on or off. In addition, the response includes a heartbeat config 414 that instructs drizzle client 208 what frequency to ping the server with heartbeat requests. This is configurable so that drizzle clients do not overload server 206 with requests to determine whether file transfers should be initiated or resumed. To accommodate change, the heatbeat config 414 also allows for the URI (uniform resource identifier) for the request to be configurable so that a URL (uniform resource locator) associated with the server and the server's configuration may be changed without requiring new versions of the client software to be downloaded. The server response may also include a media player config 416. This config includes the URI for launching a media player on local computer 202, as well as parameters for positioning the media player on the computer's screen. This allows for changing server configurations without having to download new versions of the client software.

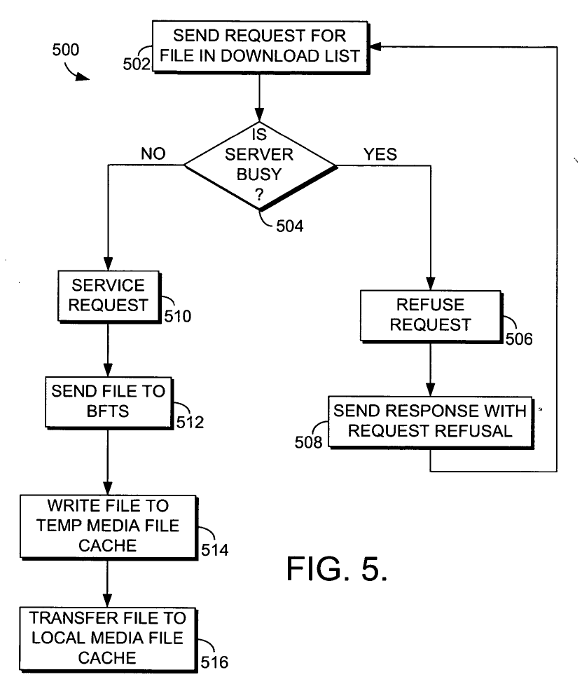

Referring now to FIG. 5, a flow diagram of an exemplary embodiment of the invention is illustrated which shows a method 500, for step 318, for transferring, from server 206 to local computer 202, media files designated on the download list. The process begins at step 502 when BFTS 210 sends a request for a media file to server 206. The request may consist of an HTTP Get for the file.

Server 206 may have the capability to throttle transfer rates and to refuse file requests to reduce loads during periods of high usage. For example, peak rate scheduler 228 may perform a scheduling process on a regular interval and alter the amount of bandwidth that server applications are permitted to use. In response, server 206 may throttle the file transfer rates by whatever mechanism already in place. If peak rate scheduler 228 determines that a particularly high level of usage exists, server 206 may refuse file requests instead of merely throttling the transfer rate. Thus, at step 504, the level of server usage is determined. If server 206 is experiencing a high level of usage, it is deemed to be busy and refuses the file request from BFTS 210, as shown at step 506. Server 208 then sends a response to BFTS 210, at step 508, indicating that the file request has been refused. Because BFTS 210 is a persistent mechanism, it will continue to send a request to download the file until server 206 is no longer busy and services the request.

If server 206 is not experiencing such a high level of usage as to be deemed busy, it services the file request, as shown at step 510. The media file is transferred, at step 512, from server 206 to BFTS 210. As discussed previously, the rate at which the file is transferred may be throttled depending on the egress loads that server 206 is experiencing.

At step 514, as BFTS 210 receives the media file, it writes the file to temporary media file cache 212. When complete, the file is moved to local media file cache 214, at step 516. Because temporary media file cache 212 is a subdirectory of local media file cache 214, the file transfer can be accomplished with a file rename.

Drizzle client 208 may periodically check the status of outstanding file transfer jobs to determine when file transfers are complete. The drizzle client may also include a status bar icon for presenting the status of the file transfer process. The icon can be configured to indicate when file transfers have been completed and new content is available, for example, by flashing. The icon can also display ready, suspended, and error states. Error states include when the client loses internet connectivity and when the BFTS 210 is disabled.

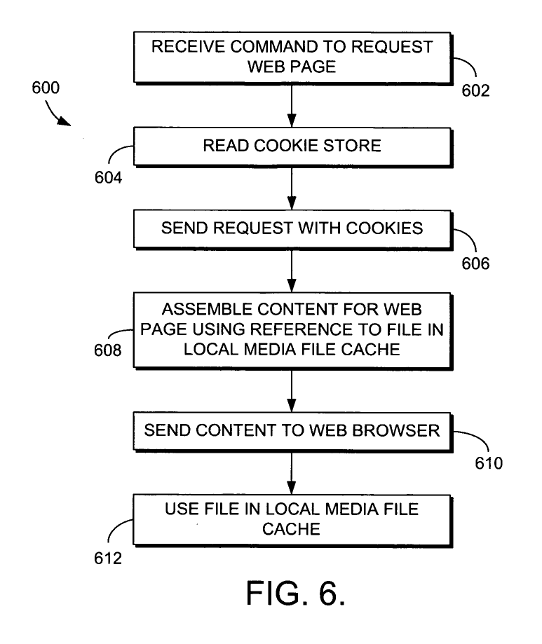

Referring now to FIG. 6, a flow diagram of an exemplary embodiment of the invention is illustrated which shows a method 600 in which a user requests a web page with a link to a media file, prompting the use of stored cookies and a cached media file. The process may begin at step 602 when web browser 216 receives a command to request a web page that contains a media file that has been previously received and stored in local media file cache 214. This may be done, for example, when a user enters the URL for the web page into web browser 216. As shown at step 604, in preparing to send the request, web browser 216 reads web browser cookie store 218 to determine if there are any stored cookies associated with the web page. If web browser 216 determines that there are cookies saved in the cookie store, it sends the cookies along with the request for the web page, as shown at step 606.

Server 206 receives the request and assembles the content for the web page, at step 608. For a media file, the web page will typically have an anchor tag, which is a reference for the location where the media file is stored, and an image tag, which is typically a thumbnail representation of the media file that is viewable when the web page is displayed. The cookies instruct the server to include, as the anchor tag, a reference to the media file stored in local media file cache 214 instead of a reference to the media file stored on the server.

At step 610, server 206 sends to web browser 216 the web page content with the reference to the media file stored in local media file cache 214. When a user selects the image tag corresponding to the media file, the file is pulled from local media file cache 214 as opposed to server 206, as shown at step 612.

Because the media file is cached on local computer 202, the invention also allows for a disconnected state. The media file may be accessed at any time, even when the computer is not connected to network 204. Thus, web browser 216 can show content from the cached media file even if local computer 202 is not connected to network 204 at the time the file is used.

### CONCLUSION

As can be understood, the present invention provides a system and method to download files in advance of their use. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages that are obvious and inherent to the system and method. It will be understood that certain features and subcombinations are of utility and may be employed without reference to other features and subcombinations. This is contemplated and within the scope of the claims.

What is claimed is:

1. A method for transferring at least one predetermined file from a server computer to a client computer in advance of its use by the client computer, the method comprising:
sending from the client computer a request for instructions to acquire at least one predetermined file, wherein the client computer includes a cache and the request includes information regarding the location of the cache;
receiving at the client computer the instructions to acquire the at least one predetermined file;
receiving at the client computer at least one cookie, wherein the at least one cookie includes information regarding the at least one predetermined file and the information regarding the location of the cache;
based on the instructions, obtaining the at least one predetermined file; and
storing the at least one predetermined file in the cache, wherein the at least one predetermined file is stored at the client computer in advance of its use by the client computer.

2. The method of claim 1, further comprising:
sending from the client computer a request for a web page, wherein the web page includes the at least one predetermined file and the request includes the at least one cookie; and
receiving data representing the web page, wherein the data includes a reference to the at least one predetermined file stored in the cache at the client computer, and the reference may be used to open the at least one predetermined file stored in the cache.

3. The method of claim 1, wherein the obtaining step comprises:
requesting the at least one predetermined file; and
receiving the at least one predetermined file.

4. The method of claim 3, wherein the file requesting step is repeated until the at least one predetermined file is received.

5. The method of claim 1, wherein the obtaining step is performed by a background file transfer process.

6. The method of claim 5, further comprising:
providing the status of the background file transfer process.

7. The method of claim 1, wherein the at least one predetermined file is a large content file.

8. The method of claim 1, wherein the at least one predetermined file is a media file, containing a video, a photo, or a combination thereof.

9. The method of claim 1, wherein the instructions request includes information regarding the contents of the cache.

10. The method of claim 9, wherein the contents of the cache include at least one cached file.

11. The method of claim 10, wherein the instructions receiving step further comprises receiving instructions to delete the at least one cached file.

12. The method of claim 11, further comprising:
based upon the instructions, deleting the at least one cached file from the cache.

13. One or more computer-readable media having computer-useable instructions embodied thereon for performing the method of claim 1.

14. A method for transferring at least one file from a server computer to a client computer in advance of the client computer's use of the file, comprising:
identifying at least one file to be transferred in advance of any specific use request by the client computer;
sending to the client computer from the server computer instructions to request the identified at least one file; and
transferring to the client computer from the server computer at least one cookie associated with the identified at least one file, the at least one cookie including information regarding the at least one file and the proper storage location of the at least one file on the client computer.

15. The method of claim 14, further comprising:
identifying at least one second file that the client computer has previously been instructed to request and that is no longer a file identified as one to be transferred in advance of any specific use request by the client computer; and
sending to the client computer from the server computer instructions to delete the identified at least one second file and the cookie associated therewith.

16. One or more computer-readable media having computer-useable instructions embodied thereon for performing the method of claim 14.

17. A system for transferring at least one predetermined file from a server computer to a client computer in advance of its use by the client computer, the system comprising:
a communicating component operative to send from the client computer a request for instructions to acquire at least one predetermined file, wherein the client computer includes a cache and the request includes information regarding the location of the cache;
a receiving component operative to receive at the client computer the instructions to acquire the at least one predetermined file and to receive at least one cookie, wherein the at least one cookie includes information regarding the at least one predetermined file and the information regarding the location of the cache;
a file obtaining component operative to obtain the at least one predetermined file based on the instructions; and
a storage component operative to store the at least one predetermined file in the cache, wherein the at least one predetermined file is stored at the client computer in advance of its use by the client computer.

18. The system of claim 17, further comprising:
a browser operative to send from the client computer a request for a web page and to receive data representing the web page, wherein:
(1) the web page includes the at least one predetermined file,
(2) the request includes the at least one cookie, and
(3) the received data includes a reference to the at least one predetermined file stored in the cache at the client computer, and the reference may be used to open that at least one predetermined file stored in the cache.

19. The system of claim 17, wherein the file obtaining component requests the at least one predetermined file and receives the at least one predetermined file.

20. The system of claim 19, wherein the file obtaining component repeats the request until the at least one predetermined file is received.

21. The system of claim 17, wherein the file obtaining component obtains the at least one predetermined file by performing a background file transfer process.

22. The system of claim 21, further comprising:
a status component operative to provide the status of the background file transfer process.

23. The system of claim 17, wherein the at least one predetermined file is a large content file.

24. The system of claim 17, wherein the at least one predetermined file is a media file, containing a video, a photo, or a combination thereof.

25. The system of claim 17, wherein the instructions request includes information regarding the contents of the cache.

26. The system of claim 25, wherein the contents of the cache include at least one cached file.

27. The system of claim 26, wherein the receiving component further receives instructions to delete the at least one cached file.

28. The system of claim 27, further comprising:
a file deleting component operative to delete the at least one cached file from the cache based upon the instructions.
